(19) United States
(12) Patent Application Publication
(10) Pub. No.: US 2008/0061023 A1
(43) Pub. Date: Mar. 13, 2008

(54) Collapsible Fluid Containers

(76) Inventor: Timothy Nicholas Moor, Stillington York (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/596,415

(22) PCT Filed: May 10, 2005
(86) PCT No.: PCT/EP05/05136

§ 371 Date: Nov. 19, 2007

(30) Foreign Application Priority Data
May 11, 2004 (GB) 0410460.0
Sep. 15, 2004 (GB) 0420490.5

(51) Int. Cl. A61J 9/00

(52) U.S. Cl. 215/11.3

(57) ABSTRACT

A collapsible container for fluids consists of a flexible bag or pouch hermetically attached to a cover. The container may be provided flat packed, pre-sterilised and hermetically packaged and may be a single use, disposable, container useful for drinking bottles for young children and babies.

The present invention relates to fluid receptacles which may be used to retain fluids particularly drinks containers and especially drinks containers that are disposable.

The invention is particularly concerned with bottles for babies and small children and more particularly with disposable baby bottles.

The present invention provides a fluid container which can be flat packed when empty, can be provided pre-sterilised, can be readily filled and which is disposable after use. In particular the invention provides a baby bottle having these desirable properties. Drinking vessels for babies and young children are typically rigid vessels provided with a removable lid to enable the vessel to be filled and cleaned and often provided with a teat to enable drinking. These vessels tend to be for multi use and may require sterilisation before each use. The vessels also take up considerable space when empty and not in use. Furthermore they cannot be sterilised easily in an environment out of the home. Collapsible containers are known such as for example from Gebrauchsmusterschrift DE 20202205 A1. However this container requires a separate stand during use, a separate clip for attachment of a handle and has no valve or seal for retaining the contents once filled. Furthermore this container is not totally disposable or recyclable in its complete form.

In one embodiment the present invention therefore provides a flat packed evacuated and/or folded container comprising a flexible bag or pouch hermetically attached to a sealed cover and further provided on the cover with an opening to enable filling of the container sealed by a non-return valve.

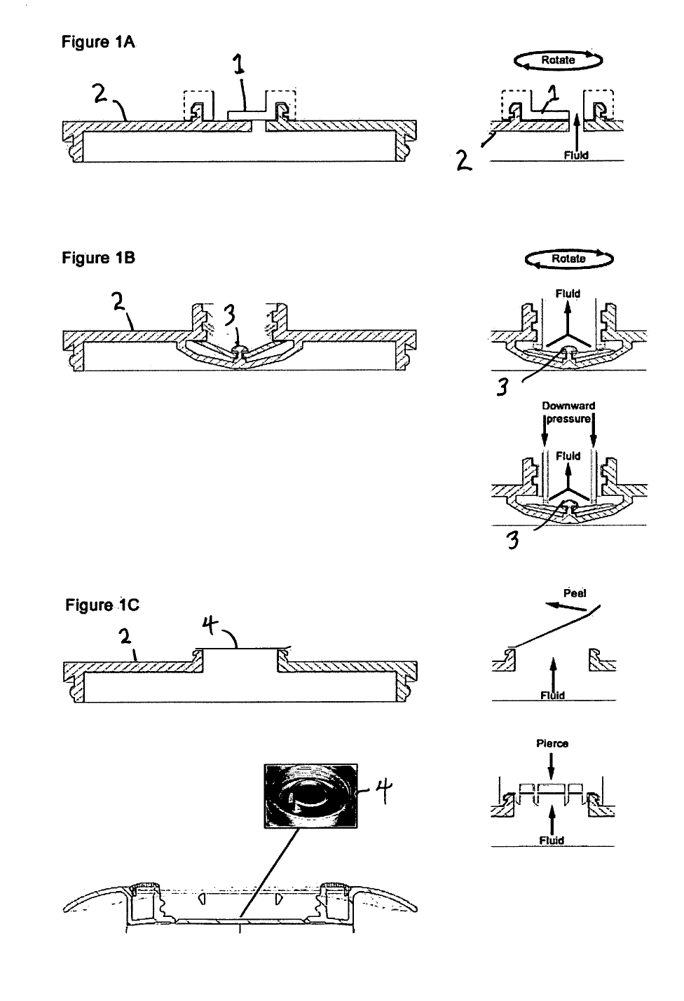

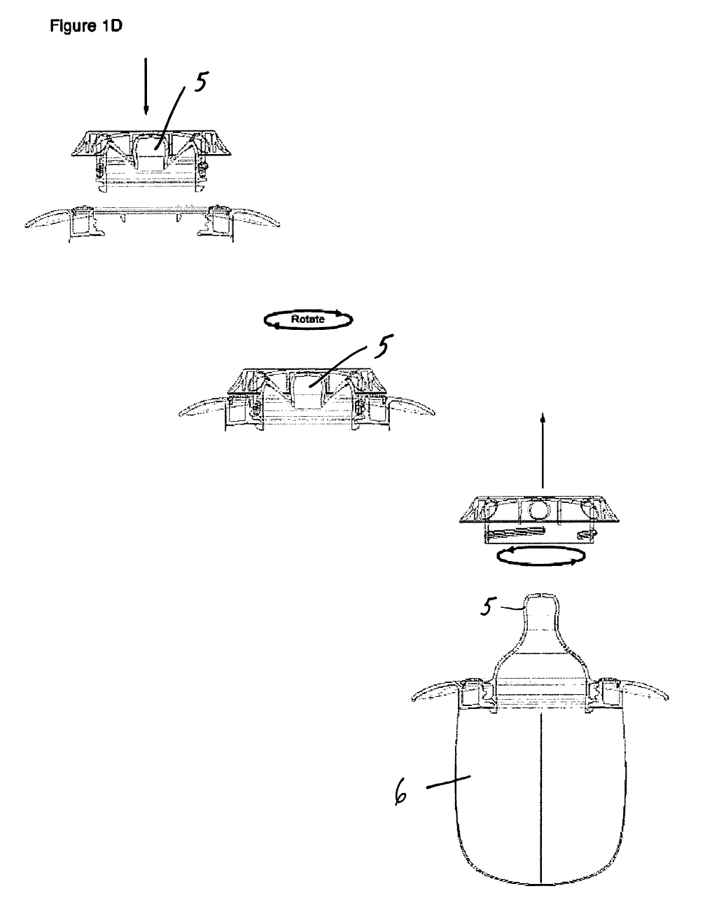

In a preferred embodiment the container is provided with a variable cover sealing system comprising a ring pull or thin film seal, such as is illustrated in FIG. 1C, and/or a fluid delivery tube through which material can be expelled from the container such as through the drinking of the contents and a plug and/or a cap/lid, as is illustrated in FIGS. 1D, 8, 9 and 10.

In another embodiment the container is sterilised prior to flat packing and in a yet further embodiment the container, preferably sterilised, may be enclosed in a hermetically sealed bag or envelope to reduce the risk of contamination prior to use. The bag or envelope may conveniently be made of material that provides protection for the container and any contents against ultra violet radiation.

A preferred container of the present invention consists of a flexible bag or pouch and a separate cover lid and a band or clip which enables the bag or pouch to be hermetically attached to the rim of the lid. The rim of the lid may be provided with a groove into which the band will fit and hold the mouth of the bag or pouch as a tight fit in the rim of the lid. In this way the bag or pouch and the lid may be made of different materials according to the function they are required to perform. In addition, or alternatively the bag or pouch may have been sealed to the rim of the lid by welding without the requirement of the band or clip. Where the bag is sealed to the lid it is preferred that it be sealed to a horizontal surface provided by the base of the lid, in this embodiment the bag or pouch may be readily sealed to the lid by ultrasonic welding.

The flexible bag or pouch may be of any size according to the use to which the container is to be put. For example where the container is to be used as a drinking bottle for young children or babies the volume of the bag or pouch when in its inflated form is at least 1 ml, preferably between 50 and 300 ml dependant upon the age. It is preferred, particularly with babies that the exact capacity of the bag is in relationship with the amount of the feed required. For other uses and situations the capacity may vary. The bag or pouch may be provided with an indicator for the volume of the contents. The bag or pouch may be made of any flexible material which should be chosen according to the use to which the container is to be put and the conditions to which it is to be subjected. It is preferred that the bag or pouch be made of a thermoplastic material such as a polymer film for example of polyolefines such as polyethylene or polypropylene or polyester such as polyethylene terephthalate or polybutylene terephthalate, polypropylene being preferred. The film may be laminar and may be provided with surface coatings if required for the use to which the container is to be put. It is preferable that the bag or pouch is transparent and that the contents can be seen, the bag and/or envelope may also be provided with writing or illustration according to the use to which the contents are to be put. It is also preferred that the bag or pouch can withstand temperatures up to 100° C. and may be provided with a temperature indicator.

The circumference of the bag or pouch at its open-end must be such that it can be fitted around the perimeter of the cover and can be held tightly to the perimeter of the cover by means of a band/clip and/or seal such as a weld. Where the bag or pouch is attached to the cover by welding it is preferred that the bag or pouch and the cover be made of similar materials and it is particularly preferred that both are made of polypropylene. A resin or adhesive may be used in some configurations of the present invention due to material selection but it is not preferred.

The cover may also be of any suitable material according to the use to which the container is to be put. The cover should however be sufficiently rigid to provide strength and integrity to the container when it contains the particular liquid for which it is designed. It is preferred that the cover be of a thermoplastic material and is preferably prepared by injection moulding. In particular we have found that polypropylene, ethylene/propylene copolymer rubbers or polyamides are particularly useful materials from which the cover can be made. Where the cover is made by injection moulding the non-return valve or seal may be integrally moulded with the cover.

In a preferred embodiment of the invention where the container is used for baby feeding the container is provided with a teat. The teat is preferably of a flexible material such as synthetic rubber particularly a silicone rubber or a thermoplastic rubber such as the styrene isoprene block copolymers sold under the trade name Kraton. The teat is preferably collapsed within the cover of the container and may be released to its useable position by removal of a plug placed over the teat. The teat may be recollapsed within the cover by replacing the plug. In this way the remaining contents of the container may be secured if a feed does not use all the contents. It is also possible to recollapse the teat without touching it thus retaining a substantially sterile environment.

In a further embodiment the underside of the plug is provided with ribs and a cavity to facilitate the compression of the teat as the plug is engaged with the cover. As a further preferment a stop is provided to ensure that the plug is engaged with the cover to the desired extent and is prevented from over engagement which could result in damage to the teat.

In a further embodiment small protrusions are provided around the inner ring of the cover so that an audible click is produced as the cover is assembled to indicate that the components of the cover are fully engaged.

In a preferred embodiment the container of the present invention comprises a baby bottle comprising a bag or pouch hermetically sealed to the base of a cover system which comprises a bag holder to which the bag or pouch is secured and a cap which may be removably engaged with the holder the cap and the holder being such that the cap secures the base of a teat within the holder. The cover system also includes a plug which fits onto and/or within the cap to depress the teat within the cover system. In this way the teat may be collapsed or brought into use by introducing or releasing the plug. In a further embodiment the holder is provided with an opening device to allow the introduction of materials to within the bag or pouch. Our preferred opening device comprises a ring pull that may be integrally moulded with the holder.

In a further embodiment the container may be used with a bottle holder and/or warmer. This may also be flat packed and made of readily disposable material such as cardboard. The holder or warmer being such that the filled container may be mounted within the holder for security purposes and/or for warming the contents. One or more of such containers may be supplied together with a package of one or several flat packed containers of the invention.

Accordingly, prior to use, the container may be assembled, the bag or pouch evacuated and/or folded so that the container lies flat to provide a compact space saving, ready for use container. When the container is to be used as a drinking vessel particularly for young children and babies it may be sterilised prior to flat packing. In a further embodiment and as part of the vacuum packaging aspect of this invention the assembled container may be vacuum packed in for example a thermoplastic film such as a polyethylene or a polypropylene film in order to preserve the sterility of the container and optionally to provide protection against ultra violet rays using barrier protection laminar films.

The ready for use containers may therefore be supplied in a flat packed space saving mode and they may be pre-sterilised and with their sterility protected. The ready for use containers may be supplied in packages of several containers for example as a six or eight container package useful for picnics or holidays.

In use the container may be removed from the packaging and the desired contents introduced into the container either through the non-return valve or by removal of the seal. The container with its contents may then be transported during, for example, travel such as for picnics and the like. Once the contents have been consumed the container may be disposed of preferably for recycle.

The containers of the present invention therefore have the following benefits particularly when used as drinking containers for children and babies. Use of the pre-sterilised container replaces the current laborious sterilising process and the associated apparatus that is required. The containers are small and compact and space saving. The filled containers can be subjected to microwave heating, warming by water, or they can be deep frozen, for storing expressed milk as one example. In a particular embodiment the container can be made of a material that will change colour when the contents reach a desired temperature. The tactile soft feeling of the flexible bag or pouch containing a drinkable liquid can provide enjoyment to the drinker, particularly a young child. Additionally, the valve holder can be shaped to allow the user to hold this part as well.

In a further embodiment of the invention ingredients such as powder, syrup, paste, cordial, dried food, liquid and/or granules particularly powdered milk or drink flavourings can be provided within the container prior to flat packing so that it may be necessary to add only water to obtain the desired drink.

The walls of the vessel should be flexible and inelastic. Flexibility means that the material at its thickness of use is able to completely recover its original shape and form from compression, concertina, flat pack, fanfold, stack, bend or twist. This comprehensive flexibility simultaneously maintains the integrity of the contents. Inelasticity ensures that the receptacle cannot be expanded beyond its desired volume.

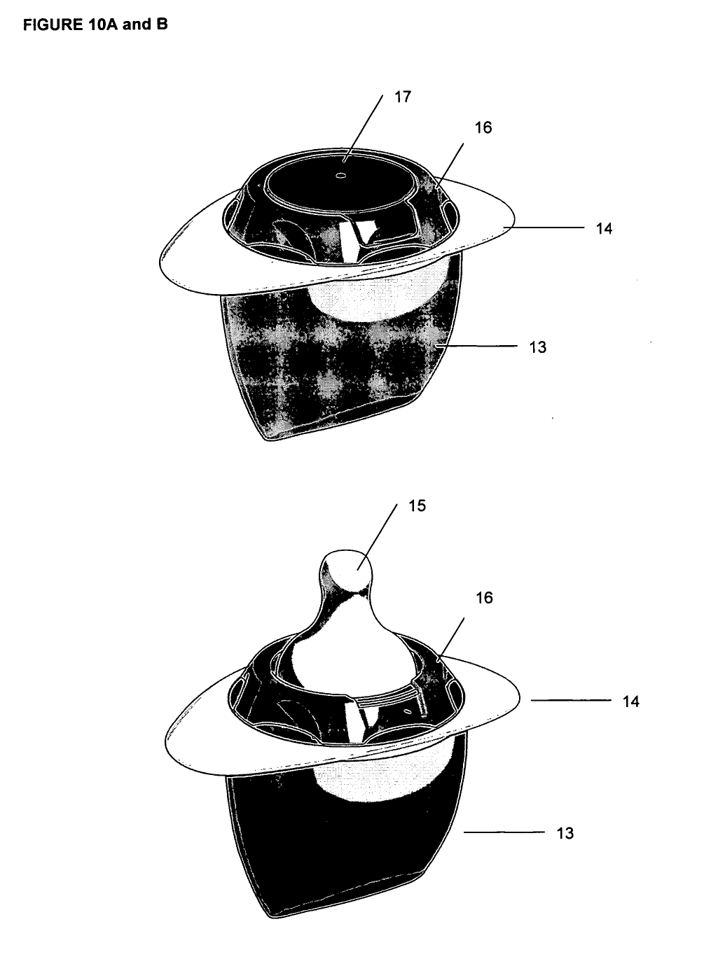

The container is conveniently made by mass production methods. Conveniently the receptacle is made in several pieces, the bag or pouch itself, the non-return valve or seal (opening device), the (non-return valve) holder, optionally a tamperproof clip and a fluid delivery tube, a cover and optionally a cap (that may contain a plug). The bag or pouch is preferably extruded and sealed at one end by a welding technique and is provided with an opening into which the (valve) holder and non return valve or seal can be. Alternatively, if pre-measured ingredients are to be put into the container prior to distribution such as milk powder or ready made formula, then the bag or pouch may be left open and not sealed until the container has been pre filled. The valve or seal holder may be injection moulded as can the valve or seal from materials such as medical grade or food grade polypropylene. A vacuum can be created within the receptacle, the receptacle is then sterilised and vacuum packed to avoid contamination prior to use. The valve or seal in one form can be made from any suitable material, it should be flexible and recover rapidly. Elastomers may be suitable or it may be made from synthetic rubber. Alternatively in another form the non-return valve may be made from the same or similar material as the non-return valve holder as can the seal illustrated in FIG. 1C. In a further embodiment the valve may be such that when it is attached, it may be rotated to provide an opening to the inside of the bag or a seal as shown in FIG. 1A. The seal (opening device) shown in FIG. 1C may come in the form of a thin film or similar material as the holder which can be removed or pierced. This is particularly useful if the container is pre-filled prior to use. In FIG. 1D, seal (opening device) has been removed, as shown in FIG. 1C, to provide an opening to the inside of the bag. To replace the seal function of the variable cover sealing system, the fluid delivery tube, cap/lid and/or plug as shown in FIGS. 10A and B configuration can provide a seal to the contents of the bag or an opening that provides access thereto by rotation, replacement or removal therefore.

We prefer that the side walls or bag of the bag or pouch are either extruded and seamless or thin film, we also prefer that they have a thickness of from 25 μm to 150 μm, more preferably 40 μm to 110 μm most preferably of approximately 100 μm. These wall thicknesses ensure the collapsible, resurrectible and flexible nature of the bag or pouch. We have also found that at this thickness the walls are strong enough and are non-elastic on inflation.

The valve holder is preferably non-flexible and when assembling the container, the non return valve can be inserted into the valve holder which, in turn, is inserted into the extruded or thin film material pouch or bag allowing the non-elastic nature of the material to mould around the shape of the valve holder providing an air tight seal which may be secured by a band or clip, or a weld. Alternatively, the non-return valve can be attached creating a seal after this process. To prevent the receptacle being tampered with, to allow grip and splash prevention, to allow increased pressures into the receptacle and to hide the open end of the bag or pouch a tamperproof clip, which may be a circular band, may be applied surrounding the edge of the valve holder. The size of the tamperproof clip is preferably less than the diameter of the valve holder providing tension when in place. Alternatively, the tamperproof clip functions can be an integral part of the (valve) holder itself, see FIG. 3B.

We prefer the (valve) holder to be rigid because the tamperproof clip, when used, can apply pressure around the top of the receptacle when attached and it is desirable that the top does not flex under the tension. Additionally, the use of a rigid (valve) holder allows the shape of the side walls to retain its shape uniformally. We prefer cylindrical shape at certain points, but, oval and/or tapered are equally desirable. It also allows the receptacle when pulled from the base in its collapsed state to receive the fluid emission and maintain a consistent volume. The (valve) holder is preferably shaped so that a fluid delivery tube, such as a mouthpiece can be readily attached to the top of the bag or pouch. Typically, as one example, a teat such as a silicon or kraton teat for babies may be appropriate.

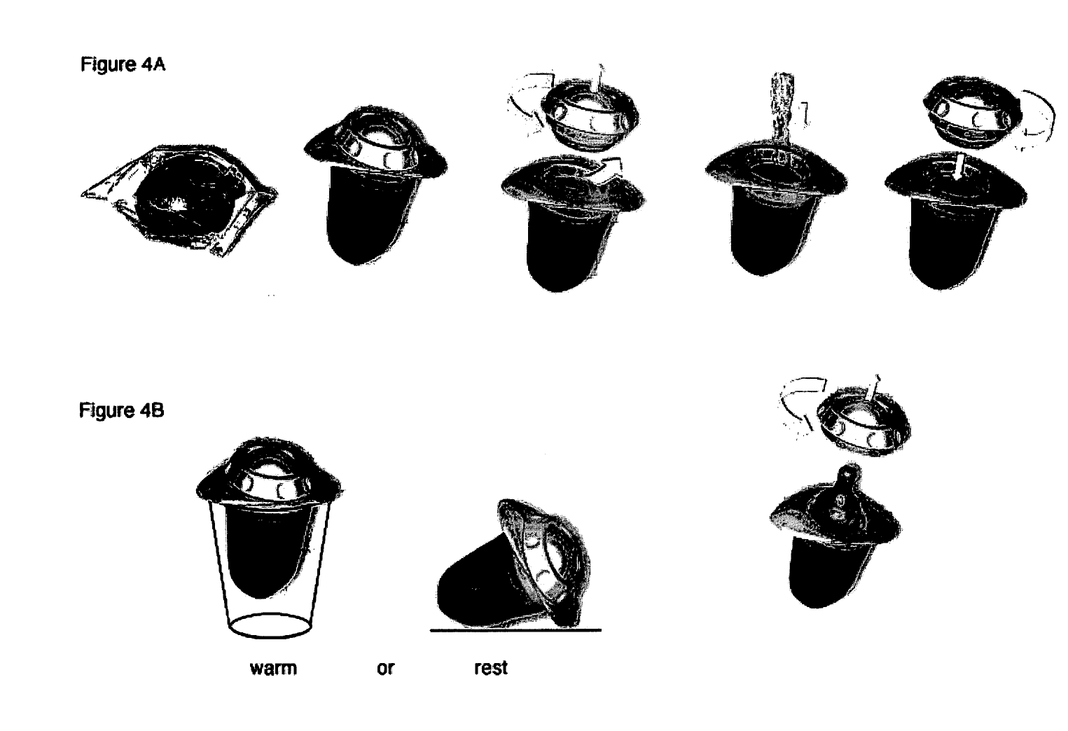

If a preferred container of the present invention is not already pre-filled with liquid, preparation of the drink can be achieved in the manner as illustrated in the flow diagram which is FIG. 4A. Upon rotation of the lid which contains a collapsed mouth piece (which in this example is a teat), it may be removed from the holder. The seal may be removed, for instance, the ring pull (which in addition to the seal has been preventing the teat from engaging with the holder). The bag or pouch may then be filled to the desired or pre-measured level with chosen liquid which may include other pre-mixed contents. Typically, by way of example, for feeding a baby the bag would have a measured amount of milk powder inside with boiled water to be added as the liquid. After filling the lid with mouthpiece would be replaced into the holder, upon rotation of the lid the mouthpiece will be secured to the holder due to the flexible nature of the mouthpiece material moulding around the more rigid material shape of the holder. A seal will be created once the mouthpiece is in the correct position which can be indicated to the user by an audible click. Additionally, the lid creates a seal in this position. With the fluid delivery tube/lid mechanism still in the sealed position, the contents may then be shaken, stirred, mixed and/or simply left in desired conditions until consumption of contents is required, see FIG. 4B. When consumption is required the lid seal may be reversed by rotation and upon removal of the lid the mouthpiece resurrects itself to the shape ready for use. After use, a seal may be re-established by positioning the lid over the mouthpiece and rotating the lid whilst applying downward pressure. In a further preferment of the present invention, a replaceable plug situated within the cap/lid is used allowing the cap/lid to remain in its secured position and resurrecting the teat when removed as illustrated in FIGS. 10A and B. This enables the container(s) described to be used at a later date preventing contamination and/or release of contents. In this embodiment of the invention, there is no need to touch the mouthpiece by hand therefore preserving sterility. Additionally, the mouthpiece once secured into position forms a seal which strong enough to prevent leakage. If the container comes pre-filled with liquid, in this embodiment, removal of the ring pull is still required and the mouthpiece can be secured as described. If the contents of the container need to be warmed or cooled the shape of the valve holder can allow the filled bag or pouch to be immersed in water without the water touching the mouthpiece or lid as illustrated in FIG. 4B again preserving the sterility of the mouthpiece and contents. It is preferable when changing the temperature of the contents of the container to have one or more of the mouthpiece/cap/plug and/or ring pull combination sealing system of the container in the sealed position.

In another embodiment of the present invention, if the seal itself cannot create an opening to the inside of the container then the mouthpiece/fluid delivery tube needs to be able to reverse the seal function. This may be accomplished either by puncturing the seal in FIG. 1C, if the seal has not already been removed; or by creating an opening through protrusion by rotation or applying a downward pressure on the attached mouthpiece forcing the flexible non return valve back as shown in FIG. 1B.

It is preferred that no resins or adhesives are used in the assembly or manufacture of the container ensuring that the integrity of the contents of the container is maintained. A vacuum can be created within the container, then sterilised and vacuum packed to avoid contamination prior to use.

The fluid containers may be used or purchased empty or they may be used or purchased with substances/fluids inside. Either way, use or purchase maybe individual, multiples of the same or combinations of different arrangements of fluid containers and/or attachments.

The fluid containers provide a flexible combination of flat-packed, sterile, inexpensive, versatile, pre-measured form of packaging that can be used in single or multiple systems or procedures that improves and maintains efficiency, quality and the integrity of the contents anywhere and at anytime. The receptacles when filled are also resistant to breakage upon impact.

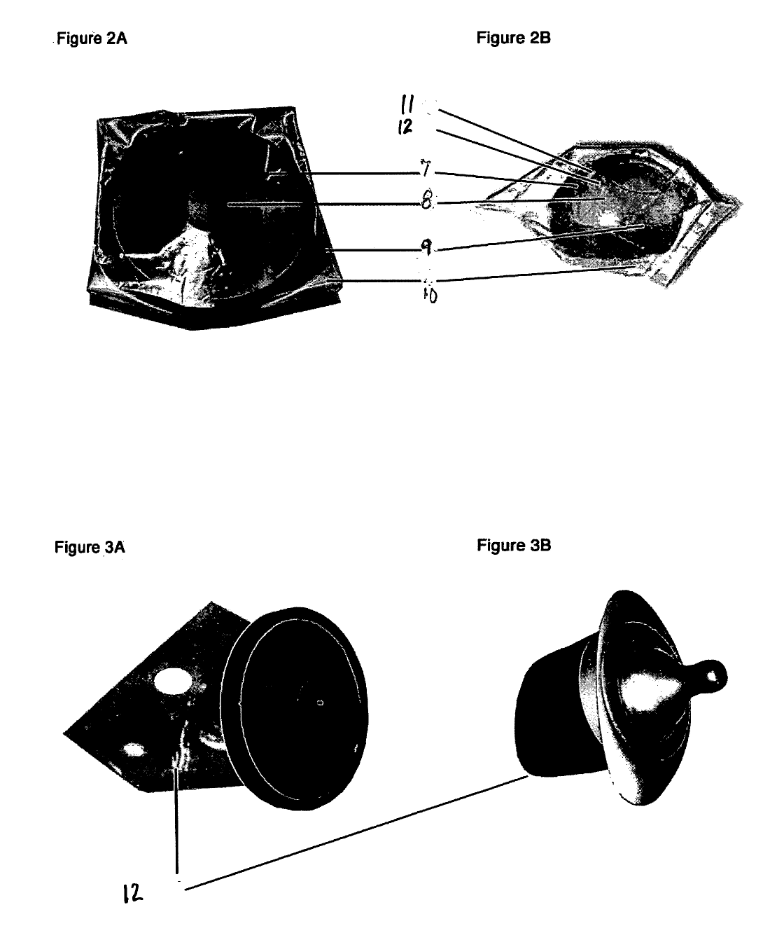

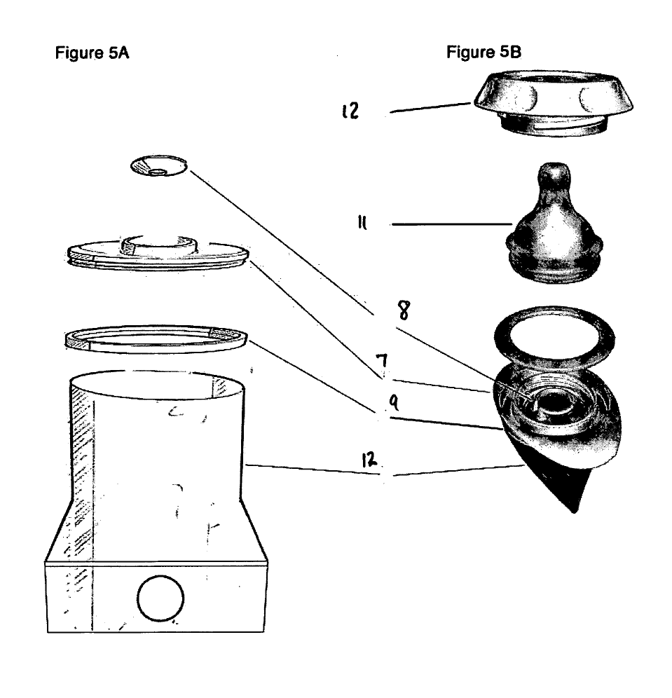

The present invention is illustrated by reference to the accompanying drawings in which FIGS. 1A and 1B show various types of non-return valves useful in one embodiment of the present invention, FIG. 1C shows a typical seal in the form of a ring pull which is useful in another embodiment of the present invention and FIG. 1D shows a typical mouthpiece and lid configuration and interaction. FIGS. 2A and 2B show a flat packed packaged container according to the present invention and FIGS. 3A and 3B show the container of FIGS. 2A and 2B in inflated form containing a liquid (including mouthpiece and lid in FIGS. 2B and 3B). FIGS. 4A and 4B show how the container in 2B and 3B can be used. FIG. 4B also illustrates how the shape of the holder can sit or hook onto water holders. FIGS. 5A and 5B are exploded views showing the components of the container and their method of assembly (including mouthpiece and lid in FIG. 5B).

FIG. 1A shows how a non-return valve (1) may be provided on the lid (2) that may be rotated to provide an opening. Similarly FIG. 1B shows how an opening may be provided by means of a valve (3) that can be rotated and depressed. FIG. 1C shows how a particular opening (1) may be provided when employing a ring pull (4).

FIG. 1D shows how a mouthpiece (such as a teat) (5) can be contained with a cap and the opening can be provided and the mouthpiece delivered and secured to the top of the bag (6) by rotation of the cap and can be compressed within the cover by means of a cap lid or plug and converted to the position for use by removal of the cap lid or plug.

FIGS. 2A and 2B shows the holder (cover) of the container (7) with a non-return valve or seal (8), the bag or pouch is not visible in FIG. 2A since it is collapsed below the holder. However FIG. 2A shows the circumferential band and/or weld (9) which attaches the bag or pouch to the holder (7) and in FIG. 2B the bag or pouch (5) is welded to the holder (7).

In FIG. 2A the container is showed protected by the impervious bag (10) which may also contain the fluid delivery tube (11) and in FIG. 2B the fluid delivery tube (11) is collapsed and temporarily secured within the cap (12).

FIGS. 3A and 3B shows the flexible bag or pouch (12) inflated and attached to the holder. The welded end of the pouch or bag may be of any shape but the illustration in FIG. 3A shows that a hole has been punched through the material to allow the container to be hung. Alternatively or in addition the flap can provide an extra place to grip.

FIGS. 4A and 4B shows how the container of FIG. 2B can be removed from the impervious bag (10) and filled and warmed and can be laid to rest without touching or otherwise contaminating the mouthpiece.

FIGS. 5A and 5B are exploded versions of the containers of FIGS. 3A and 3B.

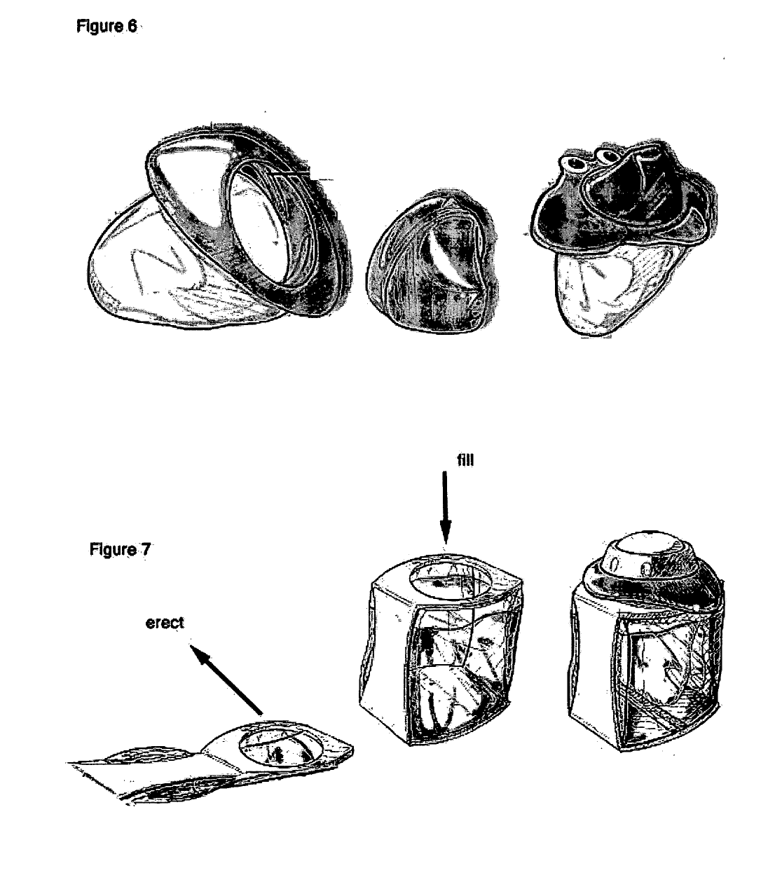

FIG. 6 illustrates how the container maybe shaped for toddlers

FIG. 7 illustrates a flat packed resurrectable baby bottle stand which can be used for warming or cooling the container and its contents if a thin film bag material is attached to the stand as illustrated. In this design the sidewalls of the warmer/cooler are collapsible but once erected and filled the baby bottle/container can rest from the top of the warmer to heat/warm the contents. Alternatively, the flat packed resurrectable baby bottle stand can be used to rest the baby bottle/ container upright.

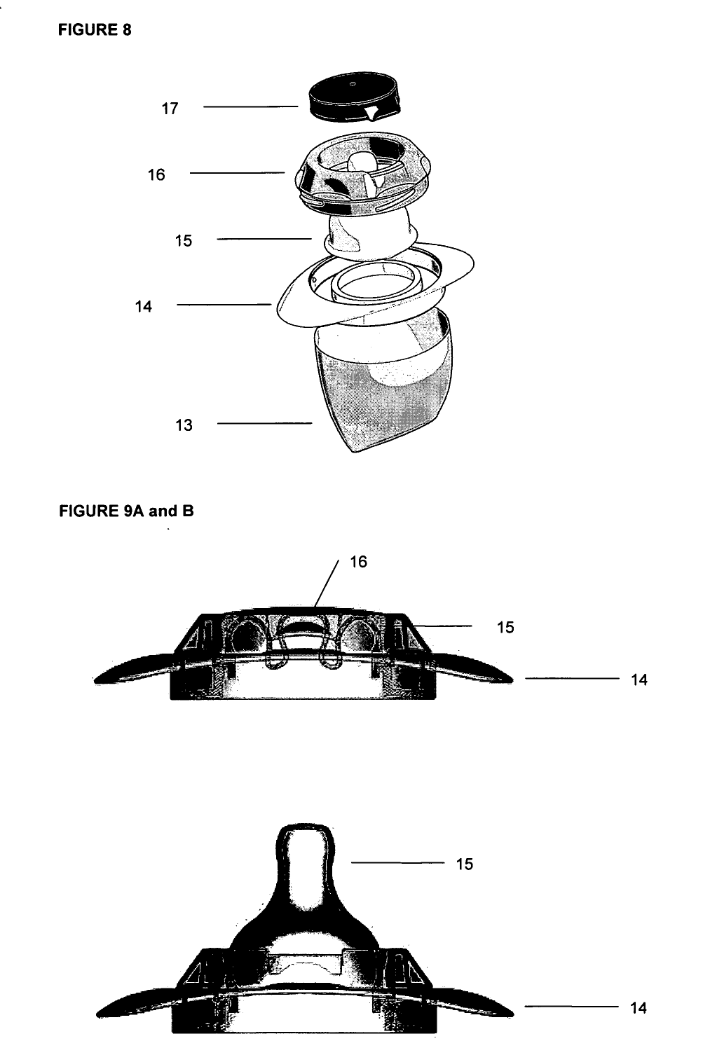

FIG. 8 shows an exploded view of a preferred container of the invention comprising a bag or pouch (13), a holder (14) to which the bag may be hermetically sealed a teat (15) which may be secured to the holder by engaging a cap (16) with the holder. Plug (17) can be applied on to the top of the cap to compress the teat (15) when it is not in use. Removal of the plug (17) then releases the teat for use. The holder (14) may be provided with a ring pull (not shown) to seal the bag or pouch prior to use and which can be removed to allow the desired contents to be introduced into the bag.

FIG. 9a is a schematic illustration showing how the teat (15) may be collapsed by placement of the plug (17) onto the cap (16) and FIG. 9b shows how the teat may be placed ready for use by removal of the plug.

FIGS. 10a and 10b show the exterior of the containers of the schematic illustration of FIGS. 9a and 9b.

The collapsible fluid container, as one example of many, can be used to ease the preparation and consumption of drinks such as coffee or tea for users who are traveling. The containers may be purchased over the counter or from vending machines and the flat packed fluid container can optionally hold mixtures of pre-measured types of coffees, milks and sugars which can have hot or boiling water added by pouring manually or injecting from a machine. With the non-return valve sealing the contents the container may be shaken or stirred to mix. Any form of fluid delivery tube may be used. The mouthpiece may provide permanent access to the contents (coffee) inside or with a simple twist or downward pressure the non-return valve can be reversed to release the contents. Due to the design of the non-return valve as illustrated in FIGS. 1A, 1B and 1C the liquid will only be expelled upon demand. Spillage will not be an issue and due to the flexible nature of the side walls, the container can fit into many spaces by molding its shape to fit.

In instances that require extreme heat resistance such as boiling water, the tamperproof band's properties and/ or valve holder shape can be used to prevent burning or injury to the user in a manner similar to that of an insulating sleeve used for paper cups.

Although the containers of the present invention have been described primarily in relation to bottles for babies and young children they may be used in a variety of other uses where space saving, single use and disposability are required. For example they may be used to provide liquids such as drinks in military operations, in travel such as in space travel or aircraft, in sporting activities and recreational activities such as walking and mountaineering. A further example of the collapsible fluid containers use is for the transport, storage and consumption of medicines to be taken orally and in veterinary applications where a pre-measured amount of material may be placed in the sterilized container which may then be flat packed and easily stored and transported prior to use. The container is also capable of storing oils, paints and the like. Using the correct fluid delivery tube such as a brush attachment or sponge, for example, the user can apply pressure by squeezing the flexible pouch or bag with the filled contents which can be applied to the desired surface. The volumetric flow can be controlled by the amount of pressure on the bag and the size of the opening created by the non-return valve, see FIGS. 1A, 1B and 1C. Additionally, using the appropriate fluid delivery tube, liquid can fill the flat packed container and either be disposed of or taken away for sampling, for example urine samples for analysis.

1. A flat packed evacuated and/or folded container comprising a flexible bag or pouch hermetically attached to a cover and further provided with means to provide an opening to enable filling and a seal such as a non-return valve to seal the evacuated and/or folded container which can be used or removed to enable filling through the opening and wherein the means to provide the opening may be replaced after the filling of the container.

2. A container according to claim 1 which is sterilised prior to flat packing.

3. A container according to any of the preceding claims enclosed in hermetically sealed packaging.

4. A container according to any of the preceding claims consisting of a flexible bag or pouch and a separate cover and a band which enables the bag or pouch to be hermetically attached to the rim of the cover.

5. A container according to any of the preceding claims consisting of a flexible bag or pouch and a separate cover that are welded together.

6. A container according to any of the preceding claims in which the volume of the container when in its inflated form is between 50 and 300 ml.

7. A container according to any of claims 1 to 5 in which the volume of the container when in its inflated form is at least 1 ml.

8. A container according to any of the preceding claims in which the bag or pouch is made of a thermoplastic material such as a polymer film for example of polyolefins such as polyethylene or polypropylene or polyester such as polyethylene terephthalate or polybutylene terephthalate.

9. A container according to any of the preceding claims in which the bag or pouch is transparent.

10. A container according to any of the preceding claims in which the bag or pouch is such that the contents are visible.

11. A container according to any of the preceding claims in which the bag or pouch is provided with pre-marked volume indicators.

12. A container according to any of the preceding claims in which the side walls of the bag or pouch are either extruded and seamless or thin film.

13. A container according to any of the preceding claims in which the side walls of the bag or pouch have a thickness of from 25 μm to 150 μm.

14. A container according to any of the preceding claims which can withstand temperatures upto 100° C.

15. A container according to any of the preceding claims in which the cover is sufficiently rigid to provide strength and integrity to the container when it contains the particular liquid for which it is designed.

16. A container according to claim 17 in which the cover is made of polypropylene, ethylene/propylene copolymers rubbers or polyamides.

17. A container according to any of the preceding claims provided with means for attachment of a fluid delivery tube.

18. A container according to claim 17 in which the fluid delivery tube is a mouthpiece.

19. A container according to any of the preceding claims containing pre-measured ingredients.

20. A container according to claim 19 in which the pre-measured ingredients comprise powder, syrup, paste, cordial, dried food, liquid and/or granules.

21. A container according to claim 19 or claim 20 in which the pre-measured ingredients is milk powder.

22. A container according to claim 19 in which the pre-measured ingredient is liquid, oil or paint.

23. A container according to claim 22 in which the liquid is sterilised water.

24. A container according to any of the preceding claims provided with a temperature indicator.

25. A container according to any of the preceding claims containing medicines to be taken orally.

26. A container comprising a bag or pouch hermetically sealed to a holder said holder being adapted to releasably engage with a cap, said cap containing a delivery mechanism for the contents of the bag or pouch and said holder containing a sealing mechanism for the bag or pouch which may be exposed by removal of the cap and broken to allow materials to be introduced into the bag or pouch wherein the cap may be replaced in the holder and thereby provide the delivery mechanism.

27. A container according to claim 26 in which the delivery mechanism is a teat.

28. A container according to claim 26 or claim 27 in which a plug is provided which may be releasably engaged with the cap.

29. A container according to claim 28 in which the plug compresses the teat when applied and releases the teat for use when it is removed.

30. A container according to claim 29 in which the teat when compressed provides the sealing mechanism.

31. A container according to any of claims 26 to 28 wherein the sealing mechanism comprises a ring pull.

32. A container according to any of claims 26 to 31 wherein the cap is engageable with the holder in a manner that secures the delivery mechanism in place.

33. A container according to claim 32 in which the cap is engageable with the holder by means of a screw thread and stops are provided on the holder to control the extent to which the cap may be engaged with the holder.

34. A package containing a plurality of flat packed containers according to any of claims 1 to 25.

35. A package according to claim 34 additionally containing one or more holders for the filled containers.

36. A package according to claim 35 wherein the holder or holders is or are collapsed.

37. The use of a container according to any of claims 1 to 33 for the preparation and/or consumption of liquids/ fluids.

38. The use of a container according to any of claims 1 to 33 in the disposal of liquids/fluids.

39. The use of a container according to claims 1 to 33 for the capture of liquid samples and/or transportation.
